(19) United States
(12) Patent Application Publication
(10) Pub. No.: US 2006/0002472 A1
(43) Pub. Date: Jan. 5, 2006

(54) Various methods and apparatuses for motion estimation

(76) Inventors: Kalpesh D. Mehta, Chandler, AZ (US); Wen-Shan Wang, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,424

(22) Filed: Jun. 30, 2004

(51) Int. Cl. H04B 1/66; H04N 11/02; H04N 11/04; H04N 7/12

(52) U.S. Cl. 375/240.16; 348/699; 375/240.24; 375/240.12

(57) ABSTRACT

Various methods, apparatuses, and systems are described to determine motion estimation. An image processing engine may have a full search motion estimation engine that matches blocks of pixel data from a first video frame to a second video frame in a raster order to determine the motion estimation. The image processing engine may further include a post processing stage to implement a search pattern algorithm on blocks of pixel data in a search window, where the search pattern starts and proceeds outward from a central region of the search window.

### FIELD

Aspects of embodiments of the invention relate to the field of video graphics; and more specifically, to motion estimation in video graphics.

### BACKGROUND

Video coding based on Motion Estimation and Motion Compensation may be used in various Video Coding standards such as variants of the Motion Picture Experts Group (MPEG). Two mechanisms may be used to perform the motion estimation. Full search algorithms may perform a complete search in a region of interest to obtain best motion estimation match amongst all of the blocks of pixels in the region of interest. Fast search algorithms may perform techniques/search patterns to reduce the scope of the block of pixel data analyzed and try to obtain an approximate best motion estimation match amongst the selected blocks of pixels analyzed. A disadvantage of the fast search algorithm approach may be that the best match block of pixel data may not really be close to being the best motion estimation match.

### BRIEF DESCRIPTION OF THE DRAWINGS

The drawings refer to embodiments of the invention in which:

FIG. 1 illustrates a block diagram of an embodiment of a first matrix of pixel data in a current video frame and a second matrix of pixel data in a reference video frame.

FIG. 2 illustrates a diagram of an embodiment of a search window of an N×N reference block of pixel data in a reference video frame.

FIG. 3 illustrates a block diagram of an embodiment of an image processing engine that includes a full search motion estimation engine to determine motion vectors on blocks of pixel data for motion estimation in a raster order and a post processing stage to implement a search pattern algorithm that starts and proceeds outward from the central region of the search window.

FIG. 4 illustrates a diagram of an embodiment of a search window composed of the plurality of blocks of pixel data from the reference video frame with motion vector coordinates of the current block of pixel data set as a central region of that search window and the radial distance from that central region.

FIGS. 5a-5c illustrate diagrams of embodiments of various search patterns that emanate from the central region of the search window and a raster order search.

FIG. 6 illustrates a block diagram of an example computer system that may use an embodiment of a chip set containing an image processing engine having a full search motion estimation engine to match blocks of pixel data from a current video frame to a previous video frame in a raster order to determine motion estimation.

FIG. 7 illustrates a block diagram of an embodiment of an image signal processor (ISP) (e.g., such as a digital signal processor for processing video and/or image data) having eight processing elements (PEs) intercoupled to each other via cluster communication registers (CCRs).

FIG. 8 illustrates a block diagram of an embodiment of a memory command handler (MCH) coupled between a memory and the CCRs, for retrieving and writing data from and to the memory for use by the processing elements (PEs).

While the invention is subject to various modifications and alternative forms, specific embodiments thereof have been shown by way of example in the drawings and will herein be described in detail. The embodiments of the invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, number of blocks of pixel data, etc., in order to provide a thorough understanding of the embodiments of the invention. It will be apparent, however, to one of ordinary skill in the art that the embodiments of the invention may be practiced without these specific details. However, the specific numeric reference should not be interpreted as a literal sequential order but rather interpreted that the first video frame is different than a second video frame. Thus, the specific details set forth are merely exemplary. The specific details may be varied from and still be contemplated to be within the spirit and scope of the present invention.

In general, various methods, systems, and apparatuses are described that determine motion vectors for motion estimation when video encoding. An N×N block of pixel data may be selected from a video frame, such as the current video frame, to be a current block of pixel data. The pixel light value data of the current block from the current video frame may be about to be encoded into equivalent bit representations. A search window composed of a plurality of blocks of pixel data from a reference video frame, such as a previous frame, may be created with the motion vector coordinates of the current block of pixel data set as a central region, i.e. center, of that search window. The pixel data of the current block may be matched with a plurality of blocks of pixel data in the search window from the reference video frame. A matching algorithm operation, such as a Sum of Absolute Difference operation, may be performed on each block of pixel data in the search window using a full search algorithm in a raster order to determine a difference, such as an absolute value, between that block of pixel data in the search window and the current block of pixel data. A first motion vector (X, Y and possibly Z) corresponding to first block of pixel data that is a closest match to the current block of pixel data amongst the blocks of pixel data in the search window may be stored. Further matching algorithm operations may be performed by reusing two or more sets of pixel data from the plurality of blocks of pixel data from previous motion vector calculations on the remaining blocks of pixel data without requesting a fetch operation to obtain the two or more sets of pixel data because they are already loaded in the engine performing the matching algorithm operation. A block of pixel data that is the closest match in pixel data and with motion vectors least in value from the current block of pixel data may be detected with a search pattern emanating from the central region of the search window, such as spiral search pattern. If two or more blocks of pixel data from the reference blocks of pixel data tie for being the closest match in pixel data, then the reference block of pixel data with motion vectors with the least radial distance to the central region of the search window may be stored.

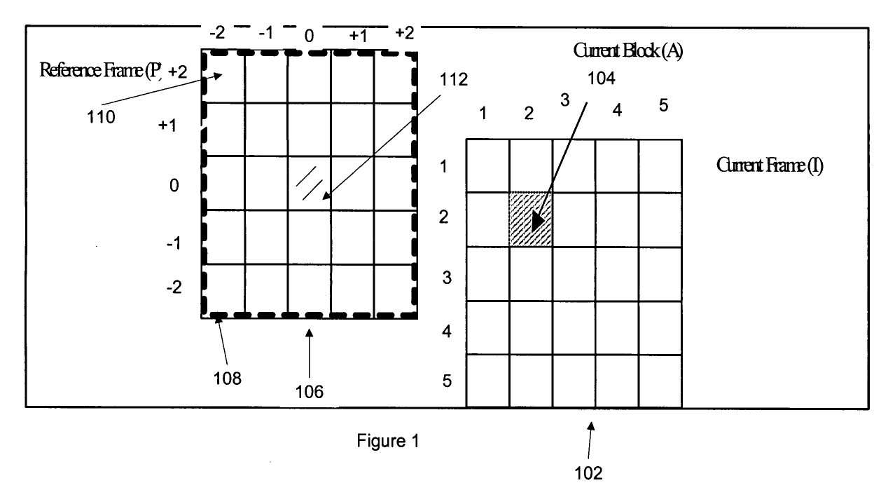

FIG. 1 illustrates a block diagram of an embodiment of a first matrix of pixel data in a current video frame and a second matrix of pixel data in a reference video frame. The first matrix of pixel data is composed of an N×N blocks of pixel data from a current video frame 102. The N×N block may be a 8×8 block of pixel data, 4×4 block, or other similar number of blocks. The current video frame may have a current block of pixel data 104. The pixel data includes the light values that the particular pixels in that block of pixel data have captured. The pixel data may be used to estimate motion when doing video encoding. The coordinates on this matrix, i.e. grid, may be referred to as motion vectors. The motion vectors may have X, Y and possibly Z coordinates that correlate to this matrix. During video compression, the motion vectors and the pixel data values for the current block of pixel data 104 may be approximately the same to a block of pixel data in a previous frame. If so, then merely the motion vector coordinates of where that particular current block 104 is located in the current video frame 102 should be sent along with a code that it references to an earlier block of pixel data which already contains the pixel light values for that particular block of pixel data.

Reference blocks of pixel data for a current block of pixel data 104 in a current video frame 102 may come from a reference video frame 106. The reference video frame 106 may be a previous video frame. The current block of pixel data 104 may be the block of pixel data from the current frame 102 that is about to be encoded. In Moving Pictures Experts Group (MPEG) technology, this current block of pixel data 104 may be called a macro-block and usually the size of this macro-block is 16×16. A search window 108 may be a region of pixel data from the previous frame 106 that the should be searched to determine the best match of pixel data for motion estimation.

In operation, an imaging processing engine that includes a full search motion estimation engine may attempt to match the current block of pixel data 104 in the current frame 102 with a block of pixel data from in the reference frame 106. The imaging processing engine selects the current N×N block of pixel data 104 about to be encoded from the current video frame 102. The light values contained in the pixel data of the current block as well as its motion vectors are about to be encoded in a video coding technique into equivalent bit representations. For example, if the motion vector represents a coordinate of row 2 column 2, then the bit representation would have to be four digits long (binary 10, 10). If the motion vector indicates row 100 column 100, then the binary equivalent bit motion vector representation would need to be 14 bits long. A similar binary encoding process may occur for the light values, etc. contained in the pixel data. Thus, sending a few bits of code that correlate the current location of this block of pixel data to a block of pixel data already transmitted and decoded can result in a lower overall bit rate.

The imaging processing engine tries to match the current block of pixel data 104 with a block of pixel data, for example, a first reference block 110, in the reference video frame 106 that has the closest pixel data and motion vectors. The image processing engine creates the search window 108 composed of a plurality of blocks of pixel data from the reference video frame 106. The reference video frame has motion vector coordinates associated with that search window 108. The motion vector coordinates of the current block of pixel data 104 from the current frame 102 can be set as the central region 112 (i.e. center 0, 0) of the search window 108 in the reference video frame 106. In this example, the search window 108 is composed of a 2×2 reference block of pixel data surrounding the central region 112 of the search window 108. Accordingly, the motion vector coordinates (2, 2) of the current block of pixel data 104 correspond to the motion vector coordinates of the N×N block of pixel in the central region 112 (0, 0) of the search window.

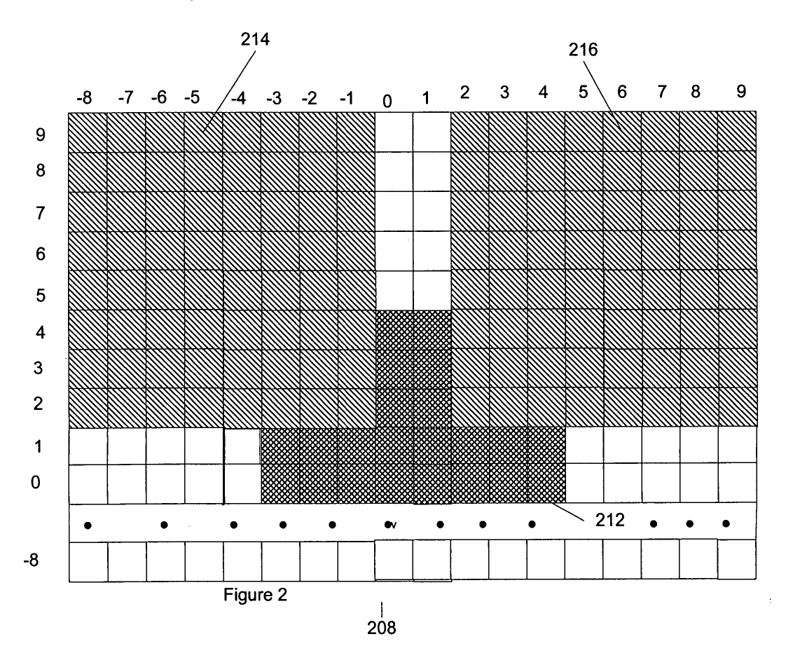

FIG. 2 illustrates a diagram of an embodiment of a search window of an N×N reference block of pixel data in a reference video frame. The search window 208 is composed of columns of pixel data from −8 through +9 columns and rows of pixel data from −8 through +9. The full-search search engine begins a full search in a raster order through the entire search window 208 of the N×N blocks of pixel data in the reference video frame. The raster order search begins in the upper left hand corner at coordinates −8, +9 and proceeds horizontally to the right. The search operates on blocks of pixel data at a time. The example size of the current block of pixel data selected from the current video frame is an 8×8 block of pixel data. That 8×8 block of pixel data is selected and a matrix of reference pixel data from −8 to +9 is generated around coordinates of the current block of pixel data to form the search window 208 of the previous frame. The example center coordinates, i.e. central region 212, of the search window of the reference video frame start at column −3, row 4 and extends to column 4, row 4 all the way down to column −3, row −3 and column 4, row −3.

The raster order search starts at the top left corner and examines a block of N×N, i.e. 8×8 in this example case, of pixel data. The initial block of pixel data examined, such as a second N×N reference block 214 indicated by a hashed marking, are columns −8 through −1 extending down from rows 9 through 2. The full search engine determines a difference, such as a Sum of the Absolute Difference, between that N×N reference block of pixel data in the search window 208 and the current block of pixel data. After that determination, the full search engine now shifts one column to the right for each clock cycle and analyzes the next new reference block of pixel data. Ten clock cycles later and ten difference determinations later, the full search engine determines a difference between a third N×N reference block of pixel data 216, and the current block of pixel data. During these ten clock cycles, the full search engine has merely had to fetch the pixel data for each new column of pixel data under analysis while being able to preserve and reuse the pixel data from previous columns in the calculation.

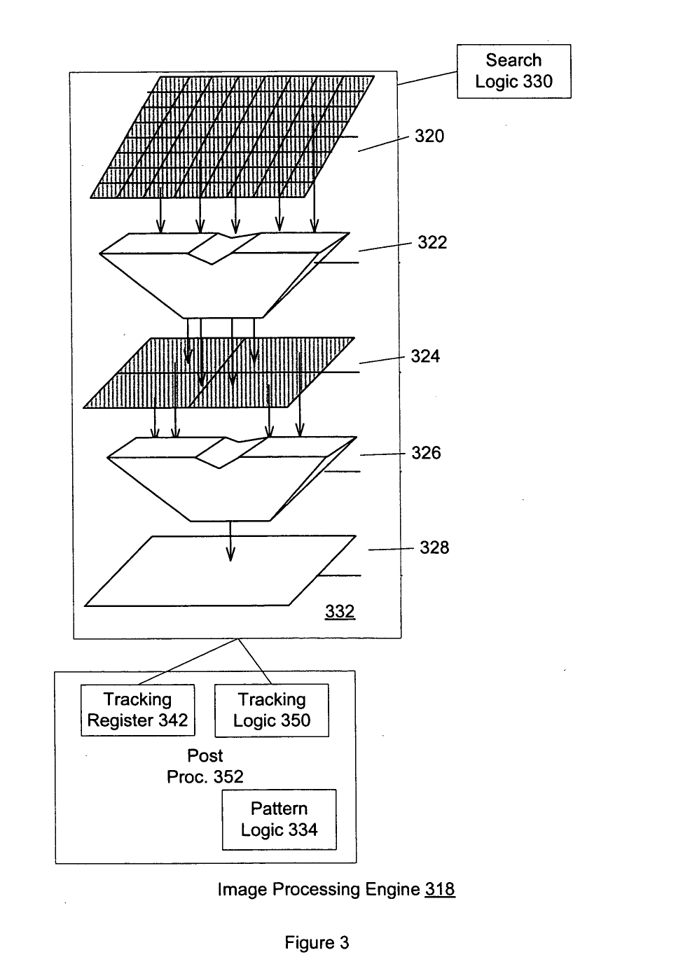

An example image processing engine that includes a full search engine motion estimation is shown in FIG. 3.

FIG. 3 illustrates a block diagram of an embodiment of an image processing engine that includes a full search motion estimation engine to determine motion vectors on blocks of pixel data for motion estimation in a raster order and a post processing stage to implement a search pattern algorithm emanating from the central region of the search window. The image processing engine 318 may consist of an N×N shift register 320, a first Adder 322 with four outputs, four 4×4 registers including a first 4×4 register 324, a second Adder 326, and a fifth N×N register 328, search logic 330, a post processing stage 352 that includes a tracking register 342, pattern logic 334, and tracking logic 350, and other similar components. A full search motion estimation engine calculation pipeline 332 may be formed by the N×N shift register 320, such as an 8×8 shift register, the first Adder 322, the sixteen 4×4 registers, the second Adder 326, the seventeenth N×N register 328, such as an 8×8 register, and the search logic block 330.

The image processing engine 318 utilizes the full search motion estimation engine calculation pipeline 332 to perform a full search in a raster order on the search window as well as to perform a matching algorithm operation, such as a Sum of Absolute Difference operation, on each block of pixel data in the search window. The full search motion estimation engine calculation pipeline 332 calculates a difference, such as an absolute value, between a particular reference block of pixel data in the search window and the current block of pixel data. For example in a simplified calculation, the light values of each pixel data in the current block of pixel data may be subtracted from the value of pixel data in reference block of pixel data. The absolute value of that difference may be determined. The sum of all the absolute differences for all of the points of pixel data in the N×N block of pixel data may compute to a numeric value of, for example 65. The smaller sum of absolute difference value between the reference block and current block represents a better match. Thus, the minimum sum of absolute difference value between those two blocks might be zero. The fifth N×N register 328 stores the sum of absolute difference value between the current block and this reference block of pixel data under analysis in the reference video frame.

The use of the N×N shift register 320 in the full search motion estimation engine calculation pipeline 332 allows two or more sets of reference pixel data to be reused in subsequent pixel data calculations on the remaining blocks of pixel data. The search logic 330 loads each individual column of pixel data into the N×N shift register 320. The N×N shift register 320 may be an 8×8 shift register. If so, eight clock cycles occur and the search logic 330 loads the 8×8 shift register up with eight columns of pixel data from the reference video frame. During the initial loading of the pixel data into the N×N shift register 320, eight clock cycles generally occur to load into the eight columns of new data. However, subsequent operations to determine the minimum sum of absolute difference value between the current block of data and the pixel blocks under analysis in the reference video frame merely use one clock cycle because merely one new column of reference blocks of pixel data is being shifted into the full search engine and the other seven columns of pixel data are already loaded into the engine.

Referring to FIG. 2, during the first eight clock cycles, the search engine loads the pixel data from columns −8 through −1. On the eighth clock cycle, a difference determination between this second reference block of pixel data 214 and the current blocks of pixels may also be calculated. On the next clock cycle, the analysis of the blocks of pixels shifts one column to the right. The N×N shift register of the full search engine shifts in the pixel data from column 0 and shifts outs the pixel data of column −8. The pixel data in columns −7 through −1 remain in the shift register and will be reused in the calculation. Merely, the pixel data from column 0 is fetched and entered into the full search engine to perform the matching difference determination on this next set of reference 8×8 block of pixel data. Therefore, a pipeline flush to fetch eight new columns of data occurs merely once every ten clock cycles when the full search in the raster order drops one row of analysis.

For example, the matching operation occurs on the third reference block of pixel data 216 on that tenth clock cycle. On the next clock cycle due to the raster ordering, the next block of pixel data in the reference video frame to be analyzed still starts in column −8, but now starts at row lower at row 8 and extends to row 1. Thus, the blocks of pixel data to be analyzed in the next cycle of the search engine will extend from column −8 to column −1 and from row 8 through row 1. The search logic loads the full search engine with eight new columns of pixel data and the matching operation begins again.

There are many matching criteria algorithms for matching a block of pixel data in a video frame, usually the current frame to be encoded, with a block of pixel data in the search window in reference frame, usually a previous frame. The full search motion estimation engine may use a Sum-of-Absolute-Difference (SAD) matching criteria also known as Mean Absolute Difference (MAD) matching criteria because of its low computational requirement without requiring any multiplication or division. The full search engine may also use matching criteria such as Mean Square Error (MSE), Normalized Cross-Correlation Function, Minimized Maximum Error (MiniMax), and other similar methods.

Referring to FIG. 3, the image processing engine 318 using a Sum-of-Absolute-Difference matching operation is described below. After the search logic 330 loads the block of pixel data in the N×N shift register 320, the first Adder 322 then performs a subtraction in absolute value operation to compare the value of the pixel data from the reference video frame to the current block of pixel data in the current frame. The first Adder 322 outputs four different values of what those absolute values are into four different discrete registers. Each discrete register, such as the first 4×4 register 324, stores its own 4×4 sub-answer block. Various MPEG encoding schemes use different size pixel blocks for the video encoding occurs. The various MPEG encoding schemes may want the sub answers in these smaller N×N sections. For example, if the particular coding scheme used an 8×8 pixel block coding scheme, then merely one 8×8 registers could be used. The four 4×4 registers, with answers/solutions from the calculation of the first Adder 322, then supply that information into the second Adder 326. The second Adder 326 takes all of that information and outputs an overall absolute difference value for that particular reference block of 8×8 pixel data in the reference video frame. The fifth N×N register stores the sum of absolute difference value between the current block of pixel data and this reference block of pixel data under analysis.

The value of the overall absolute difference value for that particular reference block of 8×8 pixel data is then sent to a post processing stage 352 of the image processing engine 318. The tracking logic 350 compares the sum of absolute difference value from that particular reference block of pixel data and the currently stored sum of absolute difference value from previously analyzed blocks of pixel data in the tracking register 342. If the sum of absolute difference value of the new reference block of pixel data is smaller i.e. closer to the value of the current video block, then that sum of absolute difference value is stored in the tracking register 342 along with the coordinates of the motion vectors from the new reference block of pixel data that created that sum of absolute difference value. In an embodiment, the image processing engine 318 looks for a minimum SAD value and captures the motion vector corresponding to minimum SAD into the tracking register 342. The image processing engine 318 detects the minimum value difference amongst all of the reference blocks of pixel data in the search window and determines what is the best matched reference block of pixel data to the current block of pixel data. The full search motion engine calculation pipeline 332 sends the motion vectors, i.e. the X, Y coordinates, corresponding to that best reference block of pixel data with the minimum absolute value into the tracking register 342. The post processing stage 318 may also use more then one register to store the current best matched reference block of pixel data and associated motion vector coordinates of that reference block.

The post processing stage also include a logic block 334 including a comparator to determine a minimum radial distance of a reference block of pixel data to the motion vector coordinates of the current block of pixel data. The logic block 334 may also implement a search pattern algorithm on the reference blocks of pixel data in a search window. The search pattern algorithm emanates from the central region of the search window. The combination of the image processing engine 318 using a raster order full search motion estimation engine and a search pattern algorithm that emanates from the central region of the search window may yield a very high throughput performance (clocks per motion vector) and better coding quality by providing smaller motion vectors resulting in a lower bit rate and a better quality (signal to noise ratios). The image processing engine 318 may be implemented for video encoding streams of real time video.

In an embodiment, the image processing engine 318 may support one SAD operation per clock throughput on an 8×8 current block of pixel data with an overall throughput of this block in the range of 30+GOPs (Giga-operations per second) running at 266 MHz.

The image processing engine 318 detects and captures the possible smallest motion vectors, i.e., coordinates, with the search pattern emanating from the central region of the search window, such as a spiral search pattern. The central region of the search window being the motion vector coordinate associated with the current block of pixel data from the current video frame. Therefore, the post processing stage 352 uses, for example, a spiral search pattern to detect the motion vectors, i.e., coordinates from the central region of the search window by determining what the coordinates of that reference block of data are in terms of radial distance from the central region of the search window.

If there are two or more reference blocks of pixel data with substantially identical sum of absolute difference values that have been determined to be the best matched block of pixel data, then the logic 334 determines which block of pixel data has the least radial distance to the central region of the search window. In an embodiment, additional registers may track the radial distance of each reference block of pixel data with the lowest SAD value.

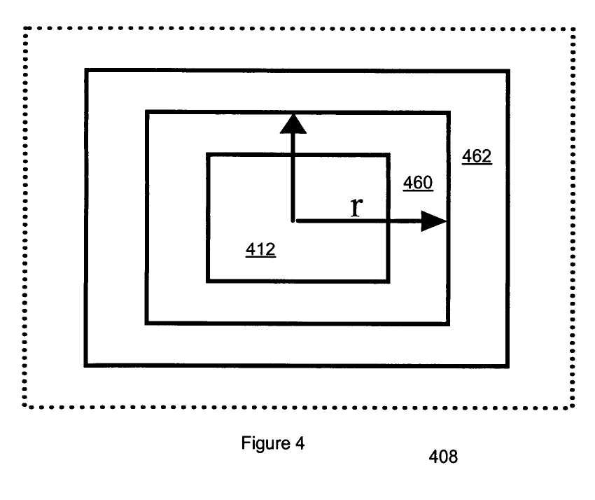

FIG. 4 illustrates a diagram of an embodiment of a search window composed of the plurality of blocks of pixel data from the reference video frame with motion vector coordinates of the current block of pixel data set as a central region of that search window and the radial distance from that central region. The motion vector coordinates of the N×N block of pixel data from the current video frame are the central region 412 of that search window 408. A 3×3 matrix of blocks of reference pixels forms the composition of the search window 408. In that search window 408, the full search begins starting left to right, drops a row, and then goes left to right again. If two or more blocks of pixel data from the reference video frame substantially tie for being a closest match to the current block of pixel data, then the block of pixel data from the reference video frame with motion vectors that are the least radial distance to the central region 412 of the search window 408 may be stored as the best match. Logic in the post processing stage computes what the radial distance is from that central region 412 in the search window 408. If the N×N best matched block occurs anywhere in the first larger rectangle of reference pixel data 460 outside the center of the search window 408, then the reference block of pixel data occurs within one radial distance of the central region 412. If the N×N best matched block occurs anywhere in the second larger rectangle of reference pixel data 462 outside the center of the search window 408, then the reference block of pixel data occurs within two radial distances of the central region 412. A first block of pixel data with the best matched pixel data falling within one radial distance would be stored as the best match over second block of pixel data with the best matched pixel data falling within two radial distances of the central region 412 of the search window 408.

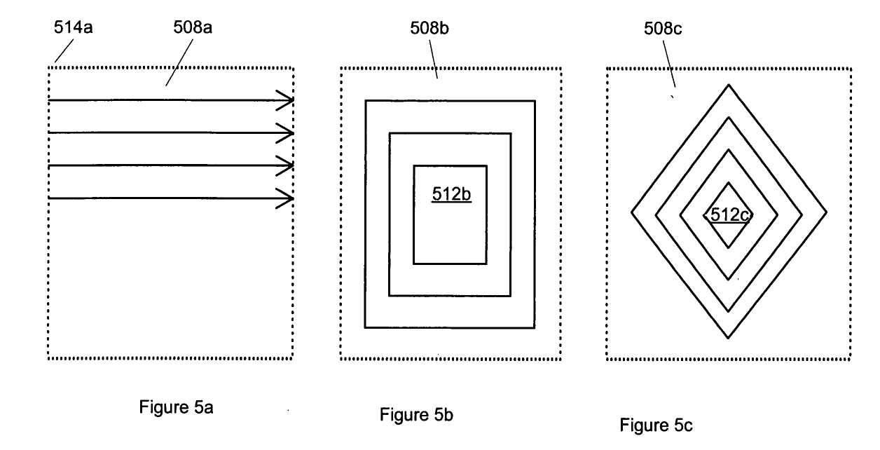

FIGS. 5a-5c illustrate diagrams of embodiments of various search patterns that emanate from the central region of the search window and a raster order search. FIG. 5a illustrates an embodiment of a raster ordered search occurring on the search window 508a of a reference video frame. Each dot represents pixel data, such as a first pixel data 514a. An N×N block of this pixel data may have a SAD operation performed that N×N block.

FIG. 5b illustrates an embodiment of a spiral pattern emanating from the central region of the search window 508b. The spiral pattern starts at the central region 512b of the search window 508b. The spiral search proceeds outward in either a clockwise or counter clockwise rotation. The spiral search may form small rectangles as the search proceeds outwardly.

FIG. 5c illustrates an embodiment of a diamond pattern emanating from the central region of the search window 508c. The more elaborate diamond shaped search pattern may also be used when determining motion vector coordinates of which reference block of pixel data is the closest to the central region 512c of the search window 508c. The spiral pattern starts at the central region 512c of the search window 508c.

The spiral and diamond search patterns identify reference block of pixel data that result in smaller motion vectors. These smaller motion vectors in turn result in lower bit rate and higher Signal to Noise Ratio (SNR).

In an embodiment, the post-processing stage receives a SAD value and corresponding motion vector. The post-processing stage uses the SAD value to update the motion vector and SAD minimum value stored in the tracking register as shown in the pseudo code below.

// FS Post-processing Stage
// SAD at (MVX, MVY) as input,
if (SAD < SADmin) then

SADmin <= SAD;
MVXmin <= MVX;
MVYmin <= MVY;

end if;

An embodiment of a Spiral search pattern may be implemented with the following changes in the pseudo code.

Spiral Search Algorithm 3(b) Post-processing Stage
// SAD at (MVX, MVY) as input
if (SAD < SADmin) then

SADmin <= SAD;
MVXmin <= MVX;
MVYmin <= MVY;
//update radial distance as defined below:
if(IMVYminl > IMVXminl) then

Radial_Distance_min <= IMVYminl;

else

Radial_Distance_min <= IMVXminl;

end if;

elsif (SAD == SADmin) then

// compute what we call radial distance as follows
if(IMVYI > IMVXI) then

Radial_Distance <= MVY;

else

Radial_Distance <= MVX;

end if;
//compare Radial distance and update MV based
on the minimum radial

distance

if(Radial_Distance < Radial_Distance_min) then

MVXmin <= MVX;
MVYmin <= MVY;
Radial_Distance_min <= Radial_Distance;

end if;

end if;

An embodiment of a Diamond search pattern may be implemented with the following changes in the pseudo code.

The algorithm may be altered to account for there being 2 or more Motion Vectors with identical SAD values by having the algorithm choosing the Motion Vector closer to the central region (0 MV) through defining Radial_Distance (r) of a motion vector (x, y) as:
Radial_Distance<=abs(x)+abs(y);

Diamond-Spiral Search Algorithm 3(c) Post-processing Stage
// SAD at (MVX, MVY) as input
if (SAD < SADmin) then

SADmin <= SAD;
MVXmin <= MVX;
MVYmin <= MVY;
//update radial distance as defined below:
Radial_Distance_mm <= IMVXminl + IMVYminl;

elsif (SAD == SADmin) then

// compute what we call radial distance as follows
Radial_Distance <= IMVXI + IMVYI;
if(Radial_Distance < Radial_Distance_min) then

MVXmin <= MVX;
MVYmin <= MVY;
Radial_Distance_min <= Radial_Distance;

end if;

end if;

The motion vector determined by the raster order full search algorithm by itself may not always be shortest vector. Two or more reference blocks of pixel data may calculate to approximately the same minimum difference value to the current block of pixel data. The diamond search pattern, spiral search pattern, or similar pattern may be applied by the post processing stage may be used to select the shortest motion vector. The combination of using a raster order full search motion estimation engine and a search pattern algorithm that emanates from the central region of the search window reduces a cost associated with coding of motion vector and coding of error block (quantized Discreet Cosine Transform of error block), to increase the bit rates or SNR from this combined approach.

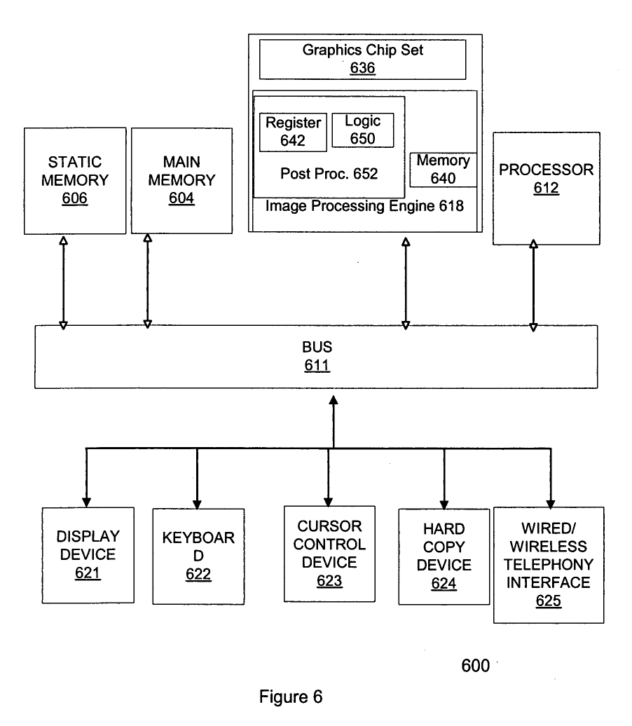

FIG. 6 illustrates a block diagram of an example computer system that may use an embodiment of a chip set containing an image processing engine having a full search motion estimation engine to match blocks of pixel data from a current video frame to a previous video frame in a raster order to determine motion estimation. In one embodiment, computer system 600 comprises a interconnect mechanism or bus 611 for communicating information, and an integrated circuit component such as a processor 612 coupled with bus 611 for processing information. One or more of the components or devices in the computer system 600 such as the processor 612 or a chip set 636 may use an embodiment of an image processing engine 618 having a full search motion estimation engine to match blocks of pixel data from a current video frame to a previous video frame in a raster order to determine motion estimation.

Computer system 600 further comprises a volatile memory such as random access memory (RAM, EDO-RAM, SD RAM, etc), or other dynamic storage device 604 (referred to as main memory) coupled to bus 611 for storing information and instructions to be executed by processor 612. Main memory 604 also may be used for storing temporary variables or other intermediate information during execution of instructions by processor 612.

The image processing engine 618 may contain a post processing stage 652 that has a register 642 and logic 650. A volatile memory 640, such as a cache, may coupled to the image processing engine 618 to store the blocks of pixel data.

Computer system 600 also comprises a read only memory (ROM) and/or other static storage device 606 coupled to bus 611 for storing static information and instructions for processor 612. The mass storage memory 606 may be a magnetic disk or optical disk and its corresponding disk drive. Mass storage memory 606 is coupled to bus 611 for storing information and instructions.

Computer system 600 may further be coupled to a display device 621, keyboard 622, a cursor control device 623, and a hard copy device 624 such as a printer. Another device that may be coupled to bus 611 is a wired/wireless communication capability 625 to communication to a phone.

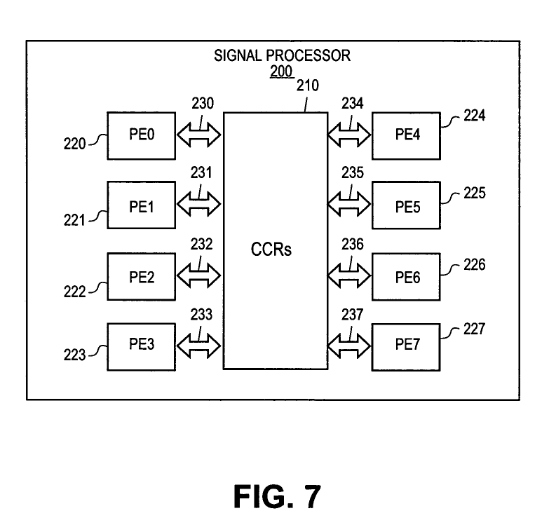

In an embodiment, the full search logic and search pattern logic may be part of a motion estimation unit in a programmable/multiprocessor architecture such as a Gila-processor™ by Intel Corporation of Santa Clara California. The motion estimation unit may be part of a larger and/or more complex image signal processor or processing element. For instance, FIG. 7 illustrates a block diagram of an embodiment of an image signal processor (ISP) (e.g., such as a digital signal processor for processing video and/or image data) having eight processing elements (PEs) intercoupled to each other via cluster communication registers (CCRs). As shown in FIG. 7, signal processor 200 includes eight programmable processing elements (PEs) coupled to cluster communication registers (CCRs) 210. CCRS 210 may be or include one or more GPRs as described above. Specifically, PEO 220 is coupled to CCRs 210 via PE CCR coupling 230, PE1 221 is similarly coupled via PE CCRs 231, PE2 222 via coupling 232, PE3 223 via coupling via 233, PE4 224 via coupling 234, PE5 225 via coupling 235, PE6 226 via coupling 236, and PE7 227 is coupled to CCRs 210 via coupling 237. According to embodiments, CCRs for coupling each PE to every other PE, may have various electronic circuitry and components to store data (e.g., such as to function as a communication storage unit, a communication register, a memory command register, a command input register, or a data output register as described herein). Such electronic circuitry and components may include registers having a plurality of bit locations, control logic, logic gates, multiplexers, switches, and other circuitry for routing and storing data.

Moreover, signal processor 200 may be coupled to one or more similar signal processors, where each signal processor may also be coupled to one or more memory and/or other signal processors (e.g., such as in a “cluster”). Also, each cluster may be coupled to one/or more other clusters. For instance signal processor 200 may be connected together in a cluster of eight or nine digital signal processors in a mesh configuration using Quad-ports. The quad-ports can be configured (statically) to connect various ISP's to other ISP's or to double data rate (DDR) random access memory (RAM), such as a “main memory” using direct memory access (DMA) channels. For example, signal processor 200 may be or may be part of programmable multi-instruction multiple data stream (MIMD) digital image processing device. More particularly, signal processor 200, whether coupled or not coupled to another signal processor, can be used for image processing related to a copier, a scanner, a printer, or other image processing device including to process a raster image, a Moving Picture Experts Group (MPEG) image, or other digital image data.

In addition, signal processor 200 can use several PE's connected together through CCRs 210 (e.g., such as where CCRs 210 is a register file switch) to provide a fast and efficient interconnection mechanism and to maximize performance for data-driven applications by mapping individual threads to PE's in such a way as to minimize communication overhead. Moreover, a programming model of the ISP's can be implemented is such that each PE implements a part of a data processing algorithm and data flows from one PE to another and from one ISP to another until the data is completely processed.

Moreover, in embodiments, a PE may be one of various types of processing elements, digital signal processors, comparison units, video and/or image signal processors for processing digital data. Similarly, a PE may be an input from one or more other ISP's, an output to one or more other ISP's, a hardware accelerator (HWA), a MEU (e.g., such as MEU 300), memory controller, and/or a memory command handler (MCH). For example, one of the PE's (e.g., PEO 220) may be an input from another ISP, one of the PE's (e.g., PE1 221) may be an output to other ISP, from one to three of the PEs (e.g., PE4, PE5 and PE6) may be configured as HWAs, at least one of the PEs (e.g., PE4) may be configured as a MEU (e.g., such as a HWA MEU, such as MEU 300), and one of the PEs (e.g., PE7 227) may be configured as a MCH functioning as a special HWA to manage the data flow for the other PE's in and out of a local memory. Thus, for example, an embodiment may include a cluster of PEs interconnected through CCRs 210, where CCRs 210 is a shared memory core of up to sixteen CCRs and each CCR is coupled to and mapped to the local address space of each PE.

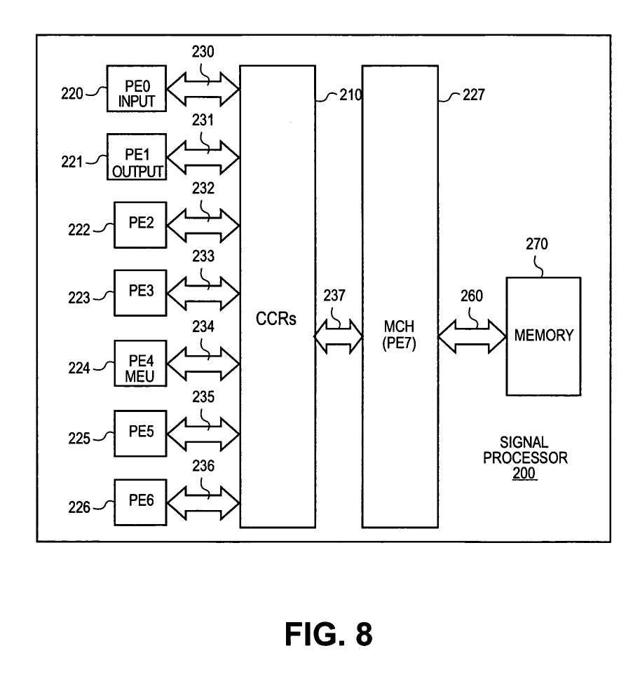

FIG. 8 is a block diagram of a memory command handler (MCH) coupled between a memory and the CCRs, for retrieving and writing data from and to the memory for use by the PEs, according to one embodiment of the invention. As shown in FIG. 8, MCH 227 (e.g., PE7 configured and interfaced to function as a memory control handler, as described above with respect to FIG. 7) is coupled via MCH to CCR coupling 237 (e.g., coupling 237, as described above with respect to FIG. 7) to CCRs 210 which in turn are coupled to each of PEO 220 through PE6 226 via CCR PEO coupling 230 through CCR PE6 coupling 236. In addition, MCH 227 is coupled to memory 270 via MCH memory coupling 260. Therefore, the PEs may read and write data to memory 270 via MCH 227 (e.g., such as by MCH 227 functioning as a central resource able to read data from and write data to CCRs 210).

According to embodiments, memory 270 may be a static RAM (SRAM) type memory, or memory 270 may be a type of memory other than SRAM. Memory 270 may be a local signal processor memory used for storing portions of images and/or for storing data temporarily, such as sum of absolute differences (SAD) values between pixels of a current data image and a prior data image. Specifically, memory 270 may provide the function of search memory 322, SAD memory 352, and/or block 870 as described above. Thus, memory 270 may SAD memory 352 by being an SRAM MCH memory, similar to a cache memory, used to temporarily store portions of images or complete image data that may originate from a DDR and may be staged in MCH 227.

Within signal processor 200, or a cluster of such signal processors (e.g., ISPs), Input PE and Output PE may be the gateways to the rest of the ISPs and can also be programmed to some level of processing. Other PEs within an ISP may also provide special processing capabilities. For instance, PE's acting as MEU's (e.g., such as MEU 300) of signal processor 200 (e.g. such as PE 4 and/or other PE's as shown in FIGS. 7 and 8) may perform video and image processing functions, such as motion estimation of objects in images of successive frames of video and/or image data, etc. For example, the apparatus, systems, and processes describe herein (e.g., such as the apparatus shown in FIGS. 7 and 8), may provide a programmable, memory efficient, and performance efficient way to estimate motion of objects in video and/or image data.

In an embodiment, a full search in raster order occurs during the process of the matching operation. A search, such as a spiral search, is then employed in the post processing stage on the results of the full search in raster order.

In one embodiment, the software used to facilitate the search algorithms and engines can be embodied onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

While some specific embodiments of the invention have been shown the invention is not to be limited to these embodiments. For example, most functions performed by electronic hardware components may be duplicated by software emulation. The functions may be combinations of software and hardware. The electronic components may be replaced with similar components that perform a similar function. N×N can mean virtually any number such as 16×16. The N×N components may be replace by N×M components such as a 16×32 component. The invention is to be understood as not limited by the specific embodiments described herein, but only by scope of the appended claims.

1. An apparatus, comprising:
an image processing engine having a full search motion estimation engine to compare blocks of pixel data in a search window from a first video frame to a second video frame in a raster order to estimate motion and a post processing stage to implement a spiral search pattern on the results of the full search motion estimation engine comparison of the blocks of pixel data, where a spiral search pattern starts and proceeds outward from a center region of the search window.

2. The apparatus of claim 1, wherein the full search motion estimation engine includes a shift register to calculate a difference between a current block of pixel data in the second video frame with a plurality of blocks of pixel data from the first video frame.

3. The apparatus of claim 1, further comprising:
logic to compute a radial distance of motion vector coordinates of a first block of pixel data from the first video frame motion vector to the motion vector coordinates of a second block of pixel data from the second video frame.

4. An system, comprising:
a chip set containing an image processing engine having a full search motion estimation engine to match blocks of pixel data from a first video frame to a second video frame in a raster order to determine motion estimation and a post processing stage to implement a search pattern on blocks of pixel data in a search window, where the search pattern starts and proceeds outward from a center region of the search window;
an interconnect coupled to the chip set; and
a volatile memory coupled to the image processing engine, wherein the volatile memory to store the blocks of pixel data.

5. The system of claim 4, wherein the post processing stage includes logic configured to implement a spiral search pattern that starts and proceeds outward from the central region of the search window on the blocks of pixel data in the search window.

6. The system of claim 4, wherein the post processing stage includes logic configured to implement a diamond search pattern that starts and proceeds outward from the central region of the search window on the blocks of pixel data in the search window.

7. The system of claim 4, wherein the full search motion estimation engine includes a calculation pipeline to perform a first matching operation between a current block of pixel data in the second video frame with a second block of pixel data from the first video frame by reusing two or more sets of pixel data from a third block of pixel data in a previous matching operation independent of requesting a fetch operation to obtain the two or more sets of pixel data.

8. The system of claim 4, further comprising:
logic to compute a radial distance of motion vector coordinates of a first block of pixel data from the first video frame to motion vector coordinates of a second block of pixel data from the second video frame.

9. A method, comprising:
determining motion vectors for motion estimation when video encoding;
selecting an N×N block of pixel data from a first video frame to be a current block of pixel data; wherein the current block of pixel data from the first video frame is about to be encoded;
performing a Sum of Absolute Difference operation on the current block of pixel data to a plurality of blocks of pixel data in a search window from a reference video frame using a full search algorithm in a raster order to determine a minimum difference between the blocks of pixel data in the search window and the current block of pixel data; and
performing a search pattern on results of the full search algorithm in the raster order on the plurality of blocks of pixel data.

10. The method of claim 9, further comprising:
searching the blocks of pixel data in a search window in a pattern that starts and proceeds outward from a center region of the search window after the full search algorithm operation is complete.

11. The method of claim 9, further comprising:
fetching pixel data for each new column of pixel data under analysis while reusing pixel data from previous columns in further matching operations.

12. The method of claim 9, further comprising:
detecting a first block of pixel data from the reference video frame that is a closest match in pixel data and with motion vectors least in value from the current block of pixel data with a diamond search pattern.

13. The method of claim 9, further comprising:
video encoding for a stream of real time video.

14. The method of claim 9, further comprising:
performing further matching operations by reusing two or more sets of pixel data from the plurality of blocks of pixel data in the reference frame from a previous matching operation independent of requesting a fetch operation to obtain the two or more sets of pixel data.

15. A apparatus, comprising:
means for determining motion vectors for motion estimation when video encoding;
means for selecting an N×N block of pixel data from a first video frame to be a current block of pixel data; wherein the current block of pixel data from the first video frame is about to be encoded;
means for comparing the current block of pixel data to a plurality of blocks of pixel data in a search window from a reference video frame using a full search algorithm in a raster order to determine a minimum difference between the blocks of pixel data in the search window and the current block of pixel data; and
means for performing a search pattern on results of the full search algorithm in the raster order on the plurality of blocks of pixel data.

16. The apparatus of claim 15, further comprising:
means for performing further matching operations by reusing two or more sets of pixel data from the plurality of blocks of pixel data in the reference frame from a previous matching operation without requesting a fetch operation to obtain the two or more sets of pixel data.

17. The apparatus of claim 15, further comprising:
means for detecting a first block of pixel data from the reference video frame that is a closest match in pixel data and with motion vectors least in value from the current block of pixel data with a spiral search pattern.

18. The apparatus of claim 15, further comprising:
means for creating a search window composed of the plurality of blocks of pixel data from the reference video frame with motion vector coordinates of the current block of pixel data set as a central region of that search window; and
storing a first block of pixel data from the reference video frame with motion vector that are the least radial distance to the central region of the search window if two or more blocks of pixel data from the reference video frame substantially tie for being a closest match to the current block of pixel data.

19. The apparatus of claim 15, further comprising:
means for fetching pixel data for each new column of pixel data under analysis while reusing pixel data from previous columns in further matching operations.

20. The apparatus of claim 15, further comprising:
means for detecting a first block of pixel data from the reference video frame that is a closest match in pixel data and with motion vectors least in value from the current block of pixel data with a diamond search pattern.

21. A system comprising:
a plurality of processing elements each having an addressing space; a plurality of general purpose registers (GPR) coupled to the reference storage device and to the search region memory, wherein each of the plurality of GPRs is shared by and mapped to the addressing space of each processing element of the plurality of processing elements,
a memory command handler (MCH) to read and write data between a plurality of communication registers and a sum of absolute difference (SAD) memory; and
a motion estimation unit having logic configured to perform a full search motion estimation engine to compare blocks of pixel data in a search window from a first video frame to a second video frame in a raster order to estimate motion and a post processing stage to implement a spiral search pattern on the results of the full search motion estimation engine comparison of the blocks of pixel data, where a spiral search pattern starts and proceeds outward from a center region of the search window.

22. A system comprising:
a plurality of image signal processors (ISPs), each including a plurality of motion estimation units; and
a memory coupled to at least one of the plurality of ISPs,
wherein a first motion estimation unit determines a plurality of sum of absolute difference (SAD) values between a reference block of data from a first frame of a stream of video data and a plurality of search windows of data from a different second frame of the stream of video data, wherein each search window includes a first portion of a first adjacent search window and a second portion of a second different adjacent search window.
